(19) United States
(12) Patent Application Publication
(10) Pub. No.: US 2007/0238816 A1
(43) Pub. Date: Oct. 11, 2007

(54) Hydrolysis-resistant polyester film with hydrolysis stabilizer

(76) Inventors: Holger Kliesch, Ginsheim-Gustavsburg (DE); Martin Jesberger, Mainz (DE); Bodo Kuhmann, Runkel (DE); Gottfried Hilkert, Saulheim (DE); Volker Schaefer, Altrip (DE)

Correspondence Address: Attention: Klaus Schweitzer;ProPat, L.L.C.,, 425-C South Sharon Amity Road, Charlotte, NC, 28211, US

(21) Appl. No.: 11/693,846

(22) Filed: Mar. 30, 2007

(30) Foreign Application Priority Data
Apr. 6, 2006 (DE) 10 2006 016 157.2

(51) Int. Cl. C08K 5/15; C08K 5/10

(52) U.S. Cl. 524/114; 524/317

(57) ABSTRACT

The invention relates to a polyester film comprising a hydrolysis stabilizer, wherein the hydrolysis stabilizer is an epoxidized alkyl ester of fatty acid or is a mixture of epoxidized alkyl esters of fatty acid or is an epoxidized fatty acid glyceride or is a mixture of epoxidized fatty acid glycerides. The form in which the hydrolysis stabilizer is added to the polyester is that of dry liquid, absorbed by a carrier material.

### CROSS-REFERENCE TO RELATED APPLICATIONS

This application claims priority to German Patent Application 10 2006 016 157.2 filed Apr. 6, 2006 which is hereby incorporated herein by reference in its entirety.

### FIELD OF THE INVENTION

The invention relates to a hydrolysis-resistant polyester film whose thickness is preferably in the range from 0.4 to 500 μm. The film comprises at least one hydrolysis stabilizer and a feature of the film is its low hydrolysis rate. The invention further relates to a process for the production of the film and to its use.

### BACKGROUND OF THE INVENTION

Films comprised of polyesters in the stated thickness range are well known. A disadvantage of these polyester films, however, is their susceptibility to hydrolysis, in particular at temperatures above the glass transition temperature of the respective polyester. Susceptibility to hydrolysis here is the property of the polyester of becoming hydrolytically degraded under moist conditions, this being discernible by way of example from a reduction in the IV or SV value (viscosity). This is particularly a limiting factor for the use of polyester films in applications with relatively great exposure to high temperatures, for example in film capacitors, cable sheathing, ribbon cables, and engine-protection films, but also in long-term applications, for example in glazing and outdoor applications.

Susceptibility to hydrolysis is particularly pronounced with aliphatic polyesters, but also with aromatic polyesters, such as PBT and PET. If the susceptibility of PET to hydrolysis becomes too great for the application, it becomes necessary to resort to PEN, which is somewhat more hydrolysis-resistant, or even to other polymers, e.g. polyetherimides or polyimides. However, these are markedly more expensive than PET and therefore are frequently unsuitable for economic reasons.

For this reason, there have been previous proposals for improving the hydrolysis resistance of polyester films via incorporation of hydrolysis stabilizers.

Polyesters relatively resistant to hydrolysis, obtained via use of carbodiimides, are known (U.S. Pat. No. 5,885,709, EP-A-0 838 500, CH-A-621 135), as also are films and fibers produced therefrom. Films produced from these polymers tend, however, both during production and during subsequent use, to evolve gases of isocyanates and of other by—and degradation products which are hazardous to health or irritant to mucous membrane. This problem is much more widespread with sheet-like structures, such as films, with large surface area, than with injection moldings or the like.

Hydrolysis stabilizers which have epoxy groups also give hydrolysis stabilization and are described by way of example in EP-A-0 292 251 A2 or U.S. Pat. No. 3,657,191. However, these compounds are based on the production of oxirane rings by means of epichlorohydrin and have a tendency inter alia caused by their terminal epoxy groups toward cleavage of low-molecular-weight toxic compounds on heating, the problems attendant on the use of these substances therefore being similar to those attendant on the use of carbodiimides. Furthermore, their incorporation into the polyester matrix is inadequate, and this leads to long reaction times and to high, undesired haze in the case of oriented polyester films.

Another disadvantage of known hydrolysis stabilizers, such as carbodiimide and other substances such as those described in EP-A-0 292 251 is that they sometimes lead to marked increases in molecular weight (viscosity rise) in the polymer during extrusion, thus making the extrusion process unstable and difficult to control.

DE 103 49 168 A1 describes mixtures comprised of epoxidized alkyl esters of fatty acid and of epoxidized fatty acid glycerides as hydrolysis stabilizers inter alia for industrial oils, vegetable esters, polyurethanes, and polyesters, the preferred embodiment of these comprising, as third component of the mixture, up to 30% by weight of a carbodiimide. There are no indications of appropriate incorporation of these hydrolysis stabilizers into a polyester film. The inventive advantageous use of a “dry liquid” is not mentioned.

### SUMMARY OF ADVANTAGEOUS EMBODIMENTS OF THE INVENTION

It was an object of the present invention to provide a hydrolysis-resistant polyester and films produced therefrom which avoid the disadvantages described of the prior art.

### BRIEF DESCRIPTION OF THE DRAWINGS

FIG. 1 is a schematic of an exemplary hazemeter which may be used to measure the haze of films in accordance with the invention.

### DETAILED DESCRIPTION OF ADVANTAGEOUS EMBODIMENTS OF THE INVENTION

This object is achieved via a polyester film which preferably comprises, alongside polyester, from 0.1 to 20% by weight (based on the weight of the finished film) of a hydrolysis stabilizer based on epoxidized alkyl esters of fatty acid and/or on epoxidized fatty acid glycerides. The principles of the statements below and of those made above are also applicable to the inventive polyester on which the film is based.

The film comprises a polyester as main constituent. Examples of suitable polyesters are polyethylene terephthalate (PET), polyethylene naphthalate (PEN), polybutylene terephthalate (PBT), polytrimethylene terephthalate (PTT), bibenzene-modified polyethylene terephthalate (PETBB), bibenzene-modified polybutylene terephthalate (PBTBB), bibenzene-modified polyethylene naphthalate (PENBB), or a mixture thereof, preference being given to PET, PBT, PEN, and PTT, and also to their mixtures and co-polyesters.

Examples of compounds that can be used for the preparation of the polyesters, alongside the main monomers, such as dimethyl terephthalate (DMT), ethylene glycol (EG), propylene glycol (PG), 1,4-butanediol, terephthalic acid (TA), benzenedicarboxylic acid, and/or 2,6-naphthalenedicarboxylic acid (NDA), are isophthalic acid (IPA), trans- and/or cis-1,4-cyclohexanedimethanol (c-CHDM, t-CHDM or c/t-CHDM) and other suitable dicarboxylic acid components (or dicarboxylic esters) and diol components. The present invention also encompasses corresponding copolyesters.

Preference is given to polymers in which 90% by weight (based on the entire amount of the dicarboxylic acid component) or more, in particular 95% by weight or more, of the dicarboxylic acid component is comprised of TA. Further preference is given to thermoplastics in which 90% by weight or more, in particular 93% by weight (based on the entire amount of the diols) or more, of the diol component is comprised of EG. Preference is also given to polymers in which the diethylene glycol content of the entire polymer is in the range from 0.5 to 2% by weight. The hydrolysis stabilizer is ignored in all of the quantitative data mentioned in this paragraph.

Other suitable polyesters are aliphatic polyesters, e.g. polyhydroxybutyrate (PHB) and its copolymers with polyhydroxyvalerate (PHV), polyhydroxybutyrate-valerate (PHBV), poly(e-caprolactone) (PCL), SP 3/6, SP 4/6 (comprised of 1,3-propanediol-adipate and, respectively, 1,4-butanediol-adipate), polycaprolactam, or generally adipic-acid-containing polyesters and the esters of other aliphatic carboxylic acids.

The film of the invention can moreover comprise inorganic or organic particles, these being needed to establish the surface topography or optical properties. Examples of these particles are calcium carbonate, apatite, silicon dioxide, titanium dioxide, aluminum oxide, crosslinked polystyrene, crosslinked polymethyl methacrylate (PMMA), zeolites, and other silicates, such as aluminum silicate. The amounts generally used of these compounds are from 0.05 to 5% by weight, preferably from 0.1 to 0.6% by weight (based on the weight of the film).

The film can also comprise further components alongside the additives mentioned, examples being flame retardants and/or free-radicals scavengers, and/or other polymers, such as polyetherimides.

The inventive film comprises a hydrolysis stabilizer, which is preferably fed in the form of a “dry liquid” directly into the extruder during production of the film, the content of the hydrolysis stabilizer preferably being in the range from 0.1 to 20.0% by weight, with preference from 1.0 to 6.0% by weight, and particularly preferably from 1.5 to 4.5% by weight, based on the weight of the film.

Epoxidized alkyl esters of fatty acid and/or epoxidized fatty acid glycerides are suitable hydrolysis stabilizers. Mixtures of glycerol esters (fatty acid glycerides) are suitable hydrolysis stabilizers, as are pure glycerol esters, and the glycerol esters here are described by the following formula:

CH₂OR₁—CHOR₂—CH₂OR₃

where R₁ and R₂ and R₃ can be either identical or different.

R₁, R₂, and R₃ preferably comply with the following formula:

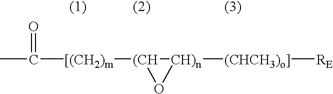

where R_{E}=CH₃ or H, and
m=0-40, preferably 7-20, particularly preferably 10-16,
n=1-10, preferably 1-4, particularly preferably 2-3, and

### O=0-4, preferably 0.

The sequence of the individual methylene (CH₂)—(1), epoxide (CHOCH)—(2), and (CHCH₃)—(3) groups here is as desired, and it is preferable here that at least 2 methylene groups (1) and particularly preferably 7 methylene groups (1) follow the carbonyl group before one or more of the groups (2) or (3) and again (1) follow. The indices therefore give merely the entire number (not the sequence) of the groups present (1), (2), or (3) in the radicals R₁, R₂, and R₃.

In glycerol ester mixtures here, the amount that should be present of radicals R_{1,2,3} where m=0 should be less than 30% by weight and preferably less than 20% by weight and particularly preferably less than 10% by weight (based on the weight of the ester mixture).

One or more of the radicals R₁ and R₂ and R₃ here can also be:

### R=H

### R=unsaturated fatty acid (double-bonded, not completely epoxidized)

### R=(PO₂)—O—(CH₂)₂—N(CH₃)₃,

these glycerol esters being less preferred, and the amount of glycerol esters containing these radicals in the glycerol ester mixtures should preferably be less than 20% by weight and particularly preferably less than 5% by weight.

Since the glycerol esters or glycerol ester mixtures used are preferably epoxidized oils of biogenic origin, these mostly also comprise small amounts of other substances (proteins, etc.), alongside the glycerol esters. The content of these substances is preferably below 10% by weight and particularly preferably below 2% by weight, based on the weight of the epoxidized oil used.

In particular, the content of compounds whose boiling point is below 210° C. is preferably less than 5% by weight and particularly preferably less than 1% by weight.

The acid number of the hydrolysis stabilizers used is preferably below 10 mg KOH per gram, and particularly preferably below 2 mg KOH per gram (DIN EN ISO 3682).

For the incorporation, and for the effectiveness, of the hydrolysis stabilization, it has proven advantageous for the viscosity of the stabilizers used to be greater than 300 mPa·s, preferably greater than 500 mPa·s, and particularly preferably greater than 700 mPa·s, at 25° C. (DIN 53018).

Particularly suitable hydrolysis stabilizers are those which have an epoxide oxygen content of at least 0.5% by weight, preferably at least 1.5% by weight, and particularly preferably greater than 2.0% by weight.

Examples of suitable epoxidized fatty acid glycerides and their mixtures are epoxidized soybean oil, epoxidized linseed oil, epoxidized rapeseed oil, epoxidized sunflower oil, and epoxidized fish oil, or are present in these epoxidized oils (the composition of the oils mentioned, in particular the nature and amount of the fatty acids present, being described by way of example in Römpp Chemie Lexikon [Römpp's Chemical Encyclopedia], 10th edition, Georg Thieme Verlag, Stuttgart).

The epoxidized alkyl esters used of fatty acid can in principle comprise esters of saturated, of unsaturated, or of polyunsaturated fatty acids, these preferably having from 1.5-15% by weight of epoxide oxygen (based on the epoxidized ester). Alkyl here means straight-chain or branched alkyl radicals preferably having from 1 to 20 carbon atoms. The fatty acids preferably comprise those which correspond to the definition of R₁—R₃ mentioned for the fatty acid glycerides.

The inventive hydrolysis stabilizers (epoxidized alkyl esters of fatty acid and/or epoxidized fatty acid glycerides) are preferably used separately, i.e. either epoxidized alkyl esters of fatty acid or a mixture of these or epoxidized fatty acid glycerides or a mixture of these. However, it is also possible to use mixtures of esters and of glycerides. In each of these cases, it is preferable that the hydrolysis stabilizers are used in the form of a “dry liquid”, as described in further detail. Particular preference is given here to the use of epoxidized fatty acid glycerides in the form of epoxidized oils of biogenic origin. The inventive hydrolysis stabilizers or the oils comprising them are known and commercially available (cf., for example, the products of the inventive examples).

The epoxidized alkyl esters of fatty acid used preferably comprise the thermally stable 2-ethylhexyl esters of unsaturated fatty acids or fatty acid mixtures of rapeseed-oil fatty acids, of linseed-oil fatty acids, of soybean-oil fatty acids, or of fish-oil fatty acids, the epoxide contents of these preferably being 1.5 to 15% by weight of epoxide oxygen (based on the epoxidized alkyl esters of fatty acid), preferably from 4 to 8% by weight.

It has moreover proven advantageous for the film to receive addition of a stabilizer in the form of a free-radical scavenger, since this counteracts the loss of active oxirane groups in extrusion via free-radical side reactions. The inventive film advantageously comprises amounts of from 50 to 15 000 ppm, preferably from 100 to 5000 ppm, particularly preferably from 300 to 1000 ppm, based on the weight of the film, of these stabilizers in the form of free-radical scavengers or heat stabilizers. The stabilizers added to the polyester are selected as desired for example from the group of the primary stabilizers, such as sterically hindered phenols or secondary aromatic amines, or from the group of the secondary stabilizers, such as thioethers, phosphites, and phosphonites, and also zinc dibutyldithiocarbamate, or a mixture comprised of primary and secondary stabilizers. Preference is given to the phenolic stabilizers. Among the phenolic stabilizers are in particular sterically hindered phenols, thiobisphenols, alkylidenebisphenols, alkylphenols, hydroxybenzyl compounds, acylaminophenols, and hydroxyphenylpropionates (appropriate compounds being described by way of example in “Kunststoffadditive” [Plastics additives], 2nd edition, Gächter Müller, Carl Hanser-Verlag, and in “Plastics Additives Handbook”, 5th edition, Dr. Hans Zweifel, Carl Hanser-Verlag). The stabilizers with the following CAS numbers: 6683-19-8, 36443-68-2, 35074-77-2, 65140-91-2, 23128-74-7, 41484-35-9, 2082-79-3 are particularly preferred, as also are IRGANOX® 1222 from Ciba Specialties, Basle, Switzerland, and in particular embodiments here the grades used comprise IRGANOX® 1010, IRGANOX® 1222, IRGANOX® 1330, and IRGANOX® 1425, or a mixture of these.

Surprisingly, it has proven more advantageous for the free-radical scavenger to be added not to the hydrolysis stabilizer but to the polyester, prior to completion of polymer preparation.

The hydrolysis stabilizer is preferably fed into the extruder in the form of a “dry liquid”, and this means that at least 50% of the hydrolysis stabilizer, preferably at least 75%, and particularly preferably more than 95%, have been absorbed by a carrier material. Suitable carrier materials are, inter alia, silicates, preferably synthetic silica, such as SIPERNAT 22LS (Degussa) or HI-SIL ABS (PPG Industries), diatomaceous silicates, calcium silicates, zeolites, aluminum phosphates, polymeric molecular sieves, or carbon molecular sieves. The median grain size d₅₀ of the particles here is preferably below 300 μm, in particular below 150 μm, and particularly preferably below 50 μm. Oil absorption (DBP, according to DIN 53601) is greater than 20 g/100 g, preferably greater than 100 g/100 g, and particularly preferably greater than 200 g/100 g, based in each case on the dry substance. The carrier material is introduced into the hydrolysis stabilizer by means of a stirrer.

The hydrolysis stabilizer [i.e. here the carrier material with absorbed hydrolysis stabilizer (=dry liquid)] and also any remaining free hydrolysis stabilizer alongside this is preferably introduced directly into the extruder(s) during film production. Good hydrolysis stabilization results are achieved using carrier material even on introduction into single-screw extruders and with feed directly into the extruder inlet, unlike with the feed of hydrolysis stabilizer without carrier material. The hydrolysis stabilizer (on carrier material) can also be introduced by way of masterbatch technology. This means that the hydrolysis stabilizer (with carrier material) is introduced in an extruder (preferably a multiscrew extruder) into an inventive polymer. During film production, this polymer is then mixed in pure form or with other inventive polymers and again extruded. However, this process is less preferred, since hydrolysis stabilizer is consumed (consumed by reaction) before the first extrusion step is complete and is then no longer available as active substance in the film.

The film, or the polyester, preferably comprises, alongside the hydrolysis stabilizer, at least 0.1% by weight, in particular at least 0.5% by weight, and particularly preferably at least 1% by weight, of carrier material.

The film of the invention is generally produced by extrusion processes known per se and is a single— or multilayer film, the hydrolysis stabilizer preferably being present in all of the layers, although there are also possible embodiments in which some of the layers have not been modified with the hydrolysis stabilizer.

The procedure in the process for production of the inventive films is advantageously such that the corresponding melts are extruded through a flat-film die, the resultant film is drawn off and quenched for solidification on one or more rolls (chill roll) in the form of a substantially amorphous prefilm, the film is then reheated and biaxially stretched (oriented), and the biaxially stretched film is heat-set. In the region of the extrusion process here it has proven advantageous not to exceed temperatures of 295° C. It is particularly advantageous for the region of the die and specifically the region of the die lip and each vicinity to be no hotter than 290° C., preferably no hotter than 285° C., and particularly preferably no hotter than 275° C.

The biaxial orientation is generally carried out sequentially. Here, it is preferable to orientate first longitudinally (i.e. in machine direction=MD) and then to orientate transversely (i.e. perpendicularly to machine direction=TD). This leads to orientation of the molecular chains. Longitudinal orientation can be carried out with the aid of two rolls running at different speeds corresponding to the desired stretching ratio. For transverse orientation, an appropriate tenter frame is generally used.

The temperature at which the orientation is carried out can vary relatively widely and depends on the desired properties of the film. Longitudinal stretching, and also transverse stretching, is generally carried out at T_{g}+10° C. to T_{g}+60° C. (T_{g}=glass transition temperature of film). The longitudinal stretching ratio is generally in the range from 2:1 to 6:1, preferably from 3:1 to 4.5:1. The transverse stretching ratio is generally in the range from 2:1 to 5:1, preferably from 3:1 to 4.5:1, and the ratio for any second longitudinal and transverse stretching carried out is preferably from 1.1:1 to 5:1.

The first longitudinal stretching can, if appropriate, be carried out simultaneously with the transverse stretching (simultaneous stretching). It has proven particularly advantageous here for the longitudinal and transverse stretching ratio in each case to be greater than 3.0.

In the heat-setting which follows, the film is kept for from 0.1 to 10 s at a temperature of from about 150 to 260° C., preferably from 200 to 245° C. Following the heat-setting or beginning therewith, the film is preferably relaxed by from 0 to 15%, in particular by from 1.5 to 8%, transversely and, if appropriate, also longitudinally, and the film is then conventionally cooled and wound up.

A film produced in this manner has markedly lower susceptibility to hydrolysis, both at room temperature and at temperatures up to 210° C., when compared with an unmodified polyester film. The stabilization here is substantially independent of the thickness of the film and of the temperature in the test range from 25 to 210° C. By way of example, a single-layer PET film of thickness 12 μm (DEG content 1% by weight and initial SV value of 720) with 2.5% by weight of a hydrolysis stabilizer comprised of epoxidized soybean oil whose epoxide oxygen content is 8% by weight (absorbed on HI-SIL ABS from PPG Industries) retains an SV value above 580 after 96 h in an autoclave with water vapor saturation at 110° C. and with this retains mechanical stability, whereas the SV value of an unstabilized film has fallen after this time to as low as below 400, and with this the film has almost no residual flexural strength. The stabilized film withstands the conditions mentioned for 200% longer prior to reaching the critical limit of 400 SV units. The same relative time improvement is also found at 80° C. and at 170° C.

It was particularly surprising that, despite the good long-term hydrolysis stabilization, no undesired viscosity increase was apparent in the extruder during film production, and no increase in the level of gelling or of fish-eyes was observed. The marked improvement in hydrolysis stabilization through the use of a carrier material (use in the form of dry liquid) was also surprising.

Films stabilized by the hydrolysis stabilizers mentioned have excellent suitability for production of products which comprise polyester films and which have been designed for long lifetime (greater than one year) or which have exposure to relatively high temperatures (above 80° C.) during their use, especially at high moisture level, and products for outdoor applications.

They therefore have excellent suitability for production of film capacitors (preferred thickness range 0.4-12 μm). These can be produced by the known conventional routes and process sequences (inter alia metallization, finishing, winding, schooping, contacting, potting, etc.) and in comparison with conventional polyester film capacitors have markedly increased lifetime and in comparison with capacitors previously described using carbodiimide stabilizers do not lead to emission of isocyanates hazardous to health, even when subjected to severe heating. For production of capacitors, it has proven advantageous for the longitudinal shrinkage of the films to be less than 4% and their transverse shrinkage to be less than 1% at 200° C., since they then have particularly good suitability for production of SMD capacitors. The inventive films preferably have these low shrinkage values.

An example of another application is ribbon cables in automobiles. For this, films (preferably 12-200 μm) are laminated to copper by means of a hot-sealable adhesive (e.g. EKP 230 hot-sealable lacquer from EKP Verpackungslacke GmbH (Germany)). Composites which comprise polyesters with the inventive hydrolysis stabilizers withstand the mechanical loads (inter alia vibrations) occurring in automobiles here for much longer than composites with conventional polyester films. However, care has to be taken here that the adhesives, too, are substantially resistant to hydrolysis (modification with the hydrolysis stabilizers mentioned being advisable in the case of polyester-based adhesives).

Another preferred application is reverse-side laminate of solar modules.

In the inventive examples which follow, each of the properties was measured in accordance with the stated standards or methods.

### Test Methods

DIN=Deutsches Institut für Normung [German Institute for Standardization]

### Standard Viscosity (SV)

Standard viscosity SV is measured—by a method based on DIN 53726—via measurement of the relative viscosity η_{rel.} of a 1% strength by weight solution in dichloroacetic acid (DCA) in an Ubbelohde viscometer at 25° C. The SV value is defined as follows:

SV=(η_{rel.}−1)·1000

### Roughness

Roughness Rₐ of the film is determined to DIN 4768 with a cut-off of 0.25 mm.

### Shrinkage

Heat shrinkage is determined on square film samples whose edge length is 10 cm. The specimens are cut out in such a way that one edge runs parallel to the machine direction and one edge runs perpendicular to the machine direction. The specimens are measured precisely (edge length L₀ being determined for each machine direction TD and MD, L₀ TD and L₀ MD) and are heat-conditioned for 15 min at the stated shrinkage temperature (here 200° C.) in a drying cabinet with air circulation. The specimens are removed and measured precisely at room temperature (edge length L_{TD} and L_{MD}). Shrinkage is calculated from the following equation:

Shrinkage[%]MD=100·(L_{0 MD}−L_{MD})/L_{0 MD}

Shrinkage[%]TD=100·(L_{0 TD}−L_{TD})/L_{0 TD}

### Haze Measurement

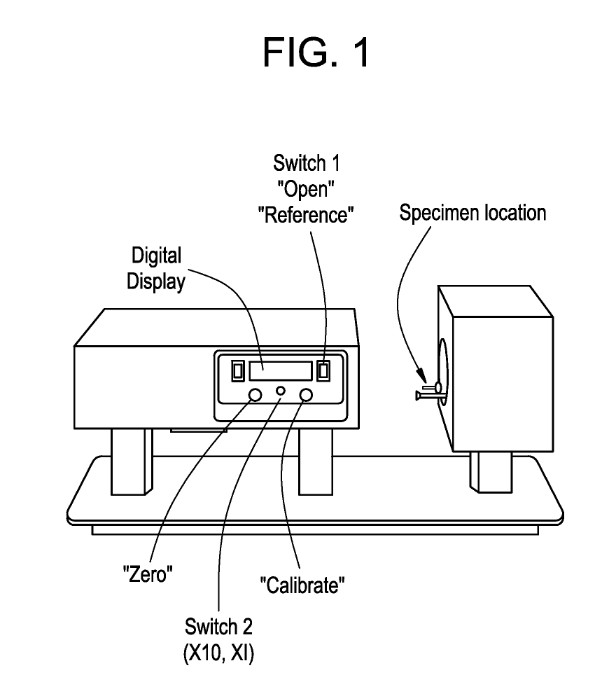

A Hazegard Hazemeter XL-211 from BYK Gardner (see FIG. 1) is used for the test. The tester is to be switched on 30 min prior to the test. Care has to be taken that the light beam passes through the sphere centrally to the outgoing aperture.

### Production, Shape, and Number of Specimens:

Five specimens of size 100·100 mm are cut out from each of the films to be studied. The longitudinal and transverse direction is indicated at the edge, since the tests take place in both machine directions.

### Haze Test

press switch 1 “OPEN”
set switch 2 to “X10” and calibrate digital display to 0.00, using the “Zero” knob
move switch 1 to “Reference” and switch 2 to “X1”
bring the digital display to 100, using the “Calibrate” knob
insert specimen longitudinally
read off displayed transparency value
calibrate the digital display to 100, using the “Calibrate” knob
set switch 1 to “OPEN”
read off displayed value for longitudinal haze
rotate specimen to transverse direction
read off displayed value for transverse haze

### Evaluation

Haze is obtained by averaging the respective 5 individual values (longitudinally and transversely).

### Autoclaving

The films (10·2 cm) are suspended in the autoclave (Adolf Wolf SANOklav ST-MCS-204) on a wire and 2 l of water are charged to the autoclave. The autoclave is closed and then heated. At 100° C., the air is displaced by water vapor by way of the outlet valve. This is closed after about 5 min, whereupon the temperature rises to 110° C. and the pressure rises to 1.5 bar. After the set time, the autoclave is automatically switched off and the films are removed after opening of the outlet valve. These are then used for determination of SV value.

### EXAMPLES

### Hydrolysis Stabilizer 1 (Hystab 1)

2 parts (parts by weight) of epoxidized soybean oil (MERGINAT ESB from HOBUM Oleochemicals GmbH, Germany) with epoxide oxygen content of 8% by weight are mixed with one part of HI-SIL ABS from PPG Industries USA.

### Hydrolysis Stabilizer 2 (Hystab 2)

POLYBIO HYSTAB 10 DL from Schafer Additivsysteme GmbH. Natural epoxidized fatty acid ester in the form of “dry liquid”. Dry liquid is based on SiO₂ particles.

### Hydrolysis Stabilizer 3 (Hystab 3)

Epoxidized soybean oil (MERGINAT ESB from HOBUM Oleochemicals GmbH, Germany) whose epoxide oxygen content is 8% by weight.

### Polymer Preparation (Hydrolysis-Resistant Polymer)

PET with hydrolysis stabilizer 1 (HyPET 1) A polyethylene terephthalate (MB1) with 10 000 ppm of SYLOBLOC 44H (Grace) and 5000 ppm of AEROSIL TT600 (Degussa) (in each case SiO₂), and also 3000 ppm of IRGANOX® 1010 (Ciba) and with DEG content of 1% is melted in a twin-screw extruder from Coperion and mixed with 12% by weight of hydrolysis stabilizer 1. Hydrolysis stabilizer 1 was fed here by means of a vibratory chute directly into the extruder intake. SV value 792.

### PET with Hydrolysis Stabilizer 2 (HyPET 2)

A polyethylene terephthalate (MB1) with 10 000 ppm of SYLOBLOC 44H (Grace) and 5000 ppm of AEROSIL TT600 (Degussa), and also 3000 ppm of IRGANOX® 1010 (Ciba) and with DEG content of 1% is melted in a twin-screw extruder from Coperion and mixed with 12% by weight of hydrolysis stabilizer 2. Hydrolysis stabilizer 2 was fed here by means of a chute directly into the extruder intake. SV value 790.

### PET with Hydrolysis Stabilizer 3 (HyPET 3)

A polyethylene terephthalate (MB1) with 10 000 ppm of SYLOBLOC 44H (Grace) and 5000 ppm of AEROSIL TT600 (Degussa), and also 3000 ppm of IRGANOX® 1010 (Ciba) and with DEG content of 1% is melted in a twin-screw extruder from Coperion and mixed with 8% by weight of hydrolysis stabilizer 3. Hydrolysis stabilizer 3 was fed here by means of a pump directly into the melt downstream of the devolatilization zone. SV value 788.

### Other Raw Materials Used

| | |
|---|---|
| Polymer P1 | PET (RT49, Invista Deutschland), |
| | SV value 790 |
| Masterbatch MB1 | 1.0% by weight of SYLOBLOC 44H, 0.5% |
| | by weight of AEROSIL TT600, and 98.2% |
| | by weight of PET; SV value 790; DEG |
| | content of 1% by weight, and also |
| | 3000 ppm of IRGANOX ® 1010 (Ciba; |
| | addition of IRGANOX during polyester |
| | polymerization). |

### Film Production:

Thermoplastic chips (HyPET 1-3 and MB1, and also P1) were mixed in the ratios stated in the examples and extruded at 278° C. in a twin-screw extruder (Japan Steel Works). The hydrolysis stabilizers (Hystab 1-2 in ex. 4+5) were fed in the form of the “dry liquid” by way of a vibratory chute directly into the extruder intake. Hystab 3 (example 6) was fed by means of a pump into the melt downstream of devolatilization. The molten polymer was drawn off from a die by way of a take-off roll. The thickness of this prefilm was 530 μm. The film was stretched by a factor of 3.4 in machine direction at 116° C. and by a factor of 3.1 transversely in a frame at 110° C. The film was then heat-set at 225° C. and relaxed transversely by 3% at temperatures of from 200 to 180° C. The final film thickness was 50 μm.

The properties of the films produced are found in the table below.

The results show that use of the hydrolysis stabilizers in the form of “dry liquid” (examples 1, 2, 4, 5) can provide even more advantages in stabilization when comparison is made with the use of the pure substances (examples 3, 6). Hydrolysis stabilization is particularly good when the “dry liquid” is fed directly into the extruder intake, this being surprisingly superior even to feed directly into the melt.

TABLE

| | | Example 1 | Example 2 | Example 3 | Example 4 | Example 5 | Example 6 |
|---|---|---|---|---|---|---|---|
| HyPET 1 | in % by wt. | 33 | | | | | |
| HyPET 2 | in % by wt. | | 33 | | | | |
| HyPET 3 | in % by wt. | | | 33 | | | |
| P1 | in % by wt. | 67 | 67 | 67 | 66 | 66 | 67.3 |
| MB1 | in % by wt. | | | | 30 | 30 | 30 |
| Hystab 1 | in % by wt. | | | | 4 | | |
| Hystab 2 | in % by wt. | | | | | 4 | |
| Hystab 3 | in % by wt. | | | | | | 2.7 |
| Film thickness | in μm | 50 | 50 | 50 | 50 | 50 | 50 |
| SV value (after film | | 767 | 773 | 771 | 777 | 769 | 773 |
| production) | | | | | | | |
| SV value after 96 h at | | 560 | 575 | 501 | 675 | 690 | 548 |
| 110° C. in autoclave | | | | | | | |
| with water saturation | | | | | | | |

1. A polyester film comprising a hydrolysis stabilizer, wherein the hydrolysis stabilizer is an epoxidized alkyl ester of fatty acid, or is a mixture of epoxidized alkyl esters of fatty acid or is an epoxidized fatty acid glyceride or is a mixture of epoxidized fatty acid glycerides.

2. The polyester film as claimed in claim 1, wherein the hydrolysis stabilizer is added to the polyester in the form of a dry liquid.

3. A polyester film comprising a hydrolysis stabilizer, wherein the hydrolysis stabilizer is a mixture comprised of one or more epoxidized alkyl esters of fatty acid and of one or more epoxidized fatty acid glycerides, and is added to the polyester in the form of a dry liquid.

4. The polyester film as claimed in claim 1, which comprises from 0.1 to 20% by weight of hydrolysis stabilizer.

5. The polyester film as claimed in claim 1, wherein the epoxide oxygen content of the hydrolysis stabilizer is at least 0.5% by weight.

6. The polyester film as claimed in claim 1, wherein the epoxidized fatty acid glycerides used comprise epoxidized soybean oil, epoxidized linseed oil, epoxidized rapeseed oil, epoxidized sunflower oil, or epoxidized fish oil, or a mixture of these.

7. The polyester film as claimed in claim 1, wherein the epoxidized alkyl esters of fatty acid used comprise the 2-ethylhexyl esters of the unsaturated fatty acids or fatty acid mixtures derived from rapeseed oil, linseed oil, soybean oil, or fish oil.

8. The polyester film as claimed in claim 1, wherein the epoxide oxygen content of the epoxidized alkyl esters of fatty acid is from 1.5 to 15% by weight.

9. The polyester film as claimed in claim 1, which comprises a free-radical scavenger.

10. The polyester film as claimed in claim 1, which comprises at least 0.1% by weight of carrier material derived from the addition of the hydrolysis stabilizer in the form of a dry liquid.

11. The polyester film as claimed in claim 10, wherein the carrier material is a silicate.

12. The polyester film as claimed in claim 1, which comprises, as polyester, polyethylene terephthalate, polybutylene terephthalate, polyethylene naphthalate, or polytrimethylene terephthalate, or a mixture of these, or copolyesters of these.

13. The polyester film as claimed in claim 1, which further comprises inorganic or organic particles.

14. The polyester film as claimed in claim 1, wherein said film is a single-layer film.

15. The polyester film as claimed in claim 1, wherein all layers of said film comprise hydrolysis stabilizer.

16. Polyester comprising a hydrolysis stabilizer, wherein the hydrolysis stabilizer is an epoxidized alkyl ester of fatty acid, or is a mixture of epoxidized alkyl esters of fatty acid or is an epoxidized fatty acid glyceride or is a mixture of epoxidized fatty acid glycerides.

17. A process for production of a polyester film as claimed in claim 1, said process comprising the steps of:
a) producing a single-layer or multilayer film via extrusion or coextrusion,
b) biaxial stretching of the film, and
c) heat-setting of the stretched film.

18. Film capacitors, cable sheathing, ribbon cables, engine-protection films, glazing films and/or outdoor films comprising film as claimed in claim 1.

19. Polyester film comprising polyester as claimed in claim 16.

20. The polyester film as claimed in claim 1, wherein the carrier material is a synthetic silica.
